(19) United States
(12) Patent Application Publication
(10) Pub. No.: US 2020/0104427 A1
(43) Pub. Date: Apr. 2, 2020

(54) PERSONALIZED NEURAL QUERY AUTO-COMPLETION PIPELINE

(71) Applicant: Microsoft Technology Licensing, LLC., Redmond, WA (US)

(72) Inventors: Bo Long, Palo Alto, CA (US); Huiji Gao, Sunnyvale, CA (US); Weiwei Guo, Foster City, CA (US); Sida Wang, Pittsburgh, PA (US)

(21) Appl. No.: 16/146,100

(22) Filed: Sep. 28, 2018

(51) Int. Cl. G06F 17/30; G06N 3/04

(52) U.S. Cl. CPC G06F 17/30973; G06N 3/04; G06F 17/30867; G06F 17/30979

(57) ABSTRACT

Techniques for providing a personalized neural query auto-completion pipeline are disclosed herein. In some embodiments, a computer system, in response to detecting user-entered text that has been entered by a user in a search field of a search engine, generates auto-completion candidates based on the user-entered text and a corresponding frequency level for each one of the auto-completion candidates, ranks the auto-completion candidates based on profile data of the user using a neural network model, and causes at least a portion of the plurality of auto-completion candidates to be displayed in an auto-complete user interface element of the search field within the user interface of the computing device of the user based on the ranking prior to the user-entered text being submitted by the user as part of a search query.

### TECHNICAL FIELD

The present application relates generally to systems, methods, and computer program products for providing a query auto-completion pipeline to improve user interface functionality and other functional aspects of a computer system.

### BACKGROUND

Auto-completion, also known as word completion, is a feature in which an application predicts the rest of a word that a user is typing and presents the predicted word to the user for use by the user, such as in the submission of a search query. Current auto-completion solutions do not sufficiently consider the specific user that is entering the word. This lack of personalization leads to a lack of relevance with respect to the particular user entering the word. As a results, significant amounts of area on the graphical user interface of the computer system with which the user is engaging are being consumed with irrelevant auto-completion suggestions, thereby wasting important electronic resources of the computer system. Other technical problems may arise as well, as will be discussed below.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 is a block diagram illustrating components of an auto-completion system, in accordance with an example embodiment.

FIG. 4 illustrates a graphical user interface providing auto-completion functionality for a search field of a search engine, in accordance with an example embodiment.

FIG. 5 illustrates an auto-completion pipeline, in accordance with an example embodiment.

FIG. 6 illustrates a neural network module, in accordance with an example embodiment.

FIG. 7 illustrates a naïve evaluator, in accordance with an example embodiment.

FIG. 8 illustrates a language-model-based evaluator, in accordance with an example embodiment.

FIG. 9 is a flowchart illustrating a method of providing an auto-completion function for a search field of a search engine, in accordance with an example embodiment.

FIG. 10 is a flowchart illustrating a method of generating auto-completion candidates, in accordance with an example embodiment.

FIG. 11 is a block diagram illustrating a mobile device, in accordance with some example embodiments.

FIG. 12 is a block diagram of an example computer system on which methodologies described herein may be executed, in accordance with an example embodiment.

### DETAILED DESCRIPTION

Example methods and systems of providing a query auto-completion pipeline to improve user interface functionality and other functional aspects of a computer system are disclosed. In the following description, for purposes of explanation, numerous specific details are set forth in order to provide a thorough understanding of example embodiments. It will be evident, however, to one skilled in the art that the present embodiments may be practiced without these specific details.

Some or all of the above problems may be addressed by one or more example embodiments disclosed herein. Some technical effects of the system and method of the present disclosure are to employ a neural network that uses profile data of a user in generating auto-completion suggestions to display to that user, thereby personalizing the auto-completion suggestions, improving their relevance to the user, and avoiding waste of important user interface display area. Additionally, in order to reduce the computational expense and the accompanying performance time associated with employing a complex neural network to score a seemingly limitless number of auto-completion candidates, the system and method of the present disclosure uses a heuristic method to generate an initial set of auto-completion candidates based on a history of previously-submitted search queries, and then ranks those generates auto-completion candidates using the neural network. As a result, the function of the computer system providing the auto-completion feature is greatly improved, as its associated computational expense is reduced and its performance speed is increased. Other technical effects will be apparent from this disclosure as well.

In some example embodiments, operations are performed by a computer system (or other machine) having a memory and at least one hardware processor, with the operations comprising: detecting user-entered text in a search field of a search engine, the user-entered text having been entered via a user interface of a computing device of a user; in response to the detecting of the user-entered text, generating a plurality of auto-completion candidates based on the user-entered text and a corresponding frequency level for each one of the plurality of auto-completion candidates, each one of the plurality of auto-completion candidates comprising predicted text absent from the user-entered text and at least a portion of the user-entered text, the frequency level indicating a number of times the corresponding predicted text has been included in a submitted search query along with the at least a portion of the user-entered text; ranking the plurality of auto-completion candidates based on profile data of the user using a neural network model, the neural network model being configured to generate a corresponding score for each one of the plurality of auto-completion candidates based on the user-entered text and the profile data, and the ranking of the plurality of auto-completion candidates being based on the corresponding scores of the plurality of auto-completion candidates; and causing at least a portion of the plurality of auto-completion candidates to be displayed in an auto-complete user interface element of the search field within the user interface of the computing device of the user based on the ranking prior to the user-entered text being submitted by the user as part of a search query.

In some example embodiments, the generating the plurality of auto-completion candidates comprises: searching a history of submitted search queries for submitted search queries comprising the user-entered text; determining that less than a threshold amount of search queries comprising the user-entered text have been submitted to the search engine; generating a modified version of the user-entered text based on the determining that less than the threshold amount of search queries comprising the user-entered text have been submitted to the search engine, the modified version being absent another portion of the user-entered text; searching the history of submitted search queries for submitted search queries comprising the modified version of the user-entered text; and generating the plurality of auto-completion candidates based on one or more results of the searching the history of submitted search queries for submitted search queries comprising the modified version of the user-entered text.

In some example embodiments, the threshold amount of search queries comprises one search query. In some example embodiments, the other portion of the user-entered text comprises at least one term of the user-entered text. In some example embodiments, the profile data comprises at least one of an industry, a job title, a company, and a location. In some example embodiments, the ranking the plurality of auto-completion candidates comprises retrieving the profile data of the user from a database of a social networking service.

In some example embodiments, the ranking the plurality of auto-completion candidates comprises: for each one of the plurality of auto-completion candidates, generating a corresponding embedding for each word in the one of the plurality of auto-completion candidates; for each one of the plurality of auto-completion candidates, inputting the corresponding embedding for each word in the one of the plurality of auto-completion candidates into a long short-term memory (LSTM) network of the neural network model, the LSTM network comprising a plurality of LSTM cells; and for each one of the plurality of auto-completion candidates, generating the corresponding score of the one of the plurality of auto-completion candidates using a state value of a last cell of the plurality of LSTM cells of the LSTM network.

In some example embodiments, the ranking the plurality of auto-completion candidates comprises: for each one of the plurality of auto-completion candidates, generating a corresponding embedding for each word in the one of the plurality of auto-completion candidates; for each one of the plurality of auto-completion candidates, generating a corresponding coherence score for each combination of a word with all of the words preceding the word in the auto-completion candidate, the coherence score indicating a coherence level between the word and all of the words preceding the word; and for each one of the plurality of auto-completion candidates, generating the corresponding score of the one of the plurality of auto-completion candidates using the corresponding coherence scores of the combinations in the auto-completion candidate.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

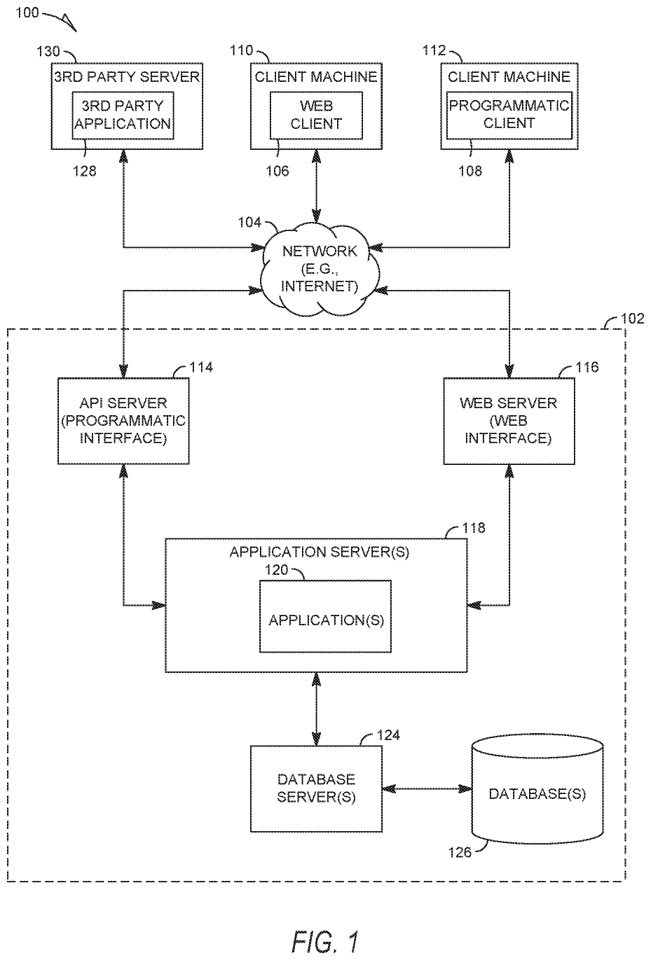

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

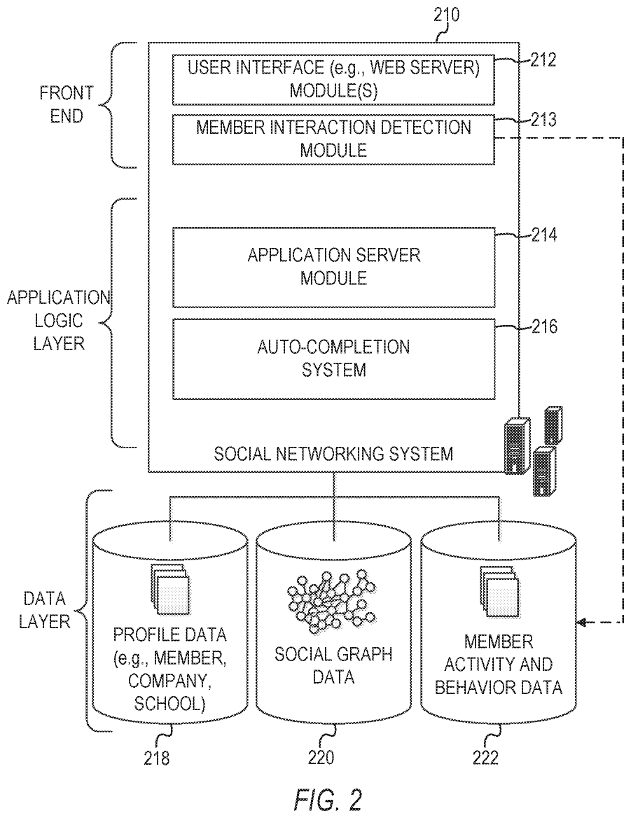

In some embodiments, the networked system 102 may comprise functional components of a social networking service. FIG. 2 is a block diagram showing the functional components of a social networking system 210, including a data processing module referred to herein as an auto-completion system 216, for use in social networking system 210, consistent with some embodiments of the present disclosure. In some embodiments, the auto-completion system 216 resides on application server(s) 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service. In some example embodiments, the application logic layer includes the auto-completion system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data teed, commonly referred to as an activity stream or content stream. In any case, the various associations and relationships that the members establish with other members, or with other entities and objects, are stored and maintained within a social graph, shown in FIG. 2 with database 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2 by the database 222. This logged activity information may then be used by the auto-completion system 216. The members' interactions and behavior may also be tracked, stored, and used by a pre-fetch system 400 residing on a client device, such as within a browser of the client device, as will be discussed in further detail below.

In some embodiments, databases 218, 220, and 222 may be incorporated into database(s) 126 in However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

Although the auto-completion system 216 is referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

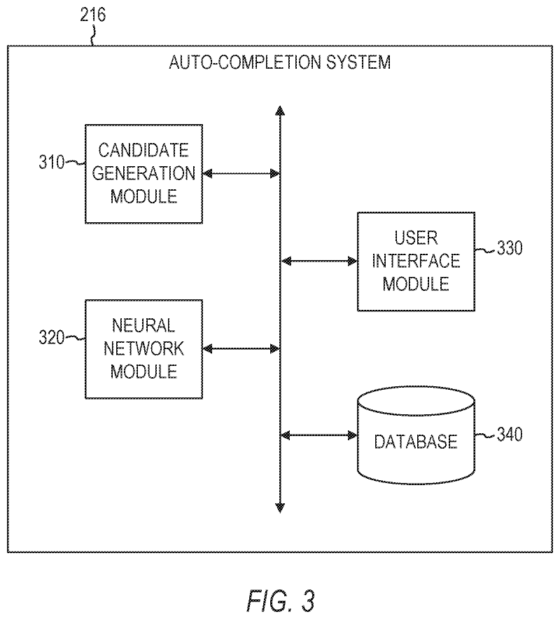

FIG. 3 is a block diagram illustrating components of an auto-completion system 216, in accordance with an example embodiment. In some embodiments, the auto-completion system 216 comprises any combination of one or more of a candidate generation module 310, a neural network module 320, a user interface module 330, and one or more database(s) 340. The modules 310, 320, and 330 and the database(s) 340 can reside on a computer system, or other machine, having a memory and at least one processor (not shown). In some embodiments, the modules 310, 320, and 330 and the database(s) 340 can be incorporated into the application server(s) 118 in FIG. 1. In some example embodiments, the database(s) 340 is incorporated into database(s) 126 in FIG. 1 and can include any combination of one or more of databases 218, 220, and 222 in FIG. 2. However, it is contemplated that other configurations of the modules 310, 320, and 330, as well as the database(s) 340, are also within the scope of the present disclosure.

In some example embodiments, one or more of the modules 310, 320, and 330 is configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs audio, tactile, and so forth). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors, and so forth). In some example embodiments, one or more of the modules 310, 320, and 330 is configured to receive user input. For example, one or more of the modules 310, 320, and 330 can present one or more GUI elements (e.g., drop-down menu, selectable buttons, text field) with which a user can submit input.

In some example embodiments, one or more of the modules 310, 320, and 330 is configured to perform various communication functions to facilitate the functionality described herein, such as by communicating with the social networking system 210 via the network 104 using a wired or wireless connection. Any combination of one or more of the modules 310, 320, and 330 may also provide various web services or functions, such as retrieving information from the third party servers 130 and the social networking system 210. Information retrieved by the any of the modules 310, 320, and 330 may include profile data corresponding to users and members of the social networking service of the social networking system 210.

Additionally, any combination of one or more of the modules 310, 320, and 330 can provide various data functionality, such as exchanging information with database(s) 340 or servers. For example, any of the modules 310, 320, and 330 can access member profiles that include profile data from the database(s) 340, as well as extract attributes and/or characteristics from the profile data of member profiles. Furthermore, the one or more of the modules 310, 320, and 330 can access social graph data and member activity and behavior data from database(s) 340, as well as exchange information with third party servers 130, client machines 110, 112, and other sources of information.

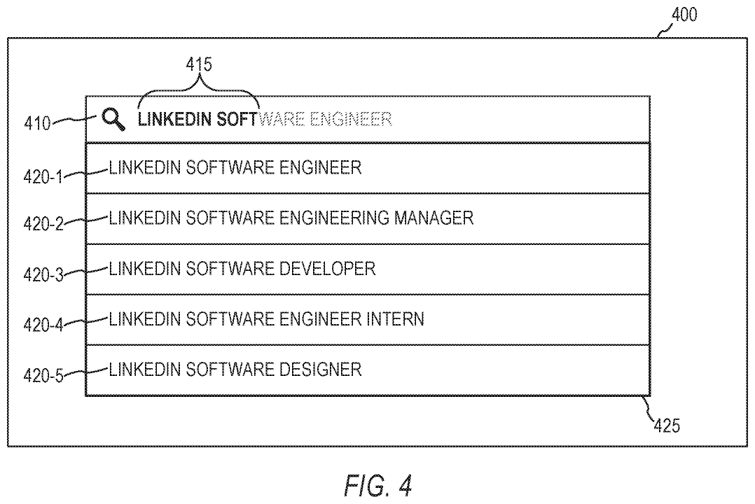

In some example embodiments, the candidate generation module 310 is configured to detecting user-entered text in a search field of a search engine, and, in response to or otherwise based on the detecting of the user-entered text, generate a plurality of auto-completion candidates based on the user-entered text. FIG. 4 illustrates a graphical user interface (GUI) 400 providing auto-completion functionality for a search field 410 of a search engine of an online service (e.g., a search engine of the social networking system 210 in FIG. 2), in accordance with an example embodiment. In FIG. 4, a user has entered user-entered text 415 (“LINKEDIN SOFT”) in the search field 410 via the GUI 400, and in response, the auto-completion system 216 has generated and displayed a auto-completion candidates 420, such as auto-completion candidate 420-1 (“LINKEDIN SOFTWARE ENGINEER”), auto-completion candidate 420-2 (“LINKEDIN SOFTWARE ENGINEERING MANAGER”), auto-completion candidate 420-3 (“LINKEDIN SOFTWARE DEVELOPER”), auto-completion candidate 420-4 (“LINKEDIN SOFTWARE ENGINEER INTERN”), and auto-completion candidate 420-5 (“LINKEDIN SOFTWARE DESIGNER”). Each one of the auto-completion candidates 420 comprises predicted text absent from the user-entered text. For example, in FIG-, 4, “WARE ENGINEER” is predicted text of auto-completion candidate 420-1, as it is not included in the user-entered text 415. Each one of the auto-completion candidates 420 also comprises at least a portion of the user-entered text 415. Although the auto-completion candidates 420 in FIG. 4 all include the entire portion of the user-entered text 415 (“LINKEDIN SOFT”), in some example embodiments, one or more of the auto-completion candidates 420 may comprise less than the entire portion of the user-entered text 415. For example, in FIG. 4, one or more of the auto-completion candidates may be absent the “LINKEDIN” portion of the user-entered text 415 and only include the “SOFT” portion of the user-entered text 415.

In some example embodiments, the generated auto-completion candidates 420 are displayed in an auto-completion user interface element 425 of the search field 410. The auto-completion user interface element 425 may comprise a corresponding selectable box for each auto-completion candidate 420. As the user enters text 415 in the search field 410, and before the user submits the entered-text 415 as a search query (e.g., by clicking or otherwise selecting a search or submit button), the auto-completion system 216 generates the auto-completion candidates 420 and displays them in the auto-completion user interface element 425 in association with the search field 410, such as in the form of a drop-down set of selectable boxes. It is contemplated that the generated auto-completion candidates 420 may be displayed in other forms as well.

In some example embodiments, the candidate generation module 310 is configured to generate an initial set of auto-completion candidates based on the user-entered text 415 and a corresponding frequency level for each one of the plurality of auto-completion candidates 420, such as by using a most popular completion method. The frequency level indicates a number of times the corresponding predicted text has been included in a submitted search query along with the at least a portion of the user-entered text. 1n the most popular completion method, when a user enters (e.g., types) input into the search field 410, the candidate generation module 310 searches a history log of previously-submitted queries for the top-n most frequent queries that use the user input string as their prefix. Data representing previous user queries and interactions are recorded by the search engine and may be used to generate an index table or log of submitted queries, which may be stored in the database(s) 340. This stored history of submitted queries captures the relationships between prefixes and queries. Therefore, in some example embodiments, when a user enters a prefix, such as user-entered text 415, in the search field 410, the candidate generation module 310 generates the initial list of auto-completion candidates by retrieving, from the database(s) 340, the most popular or frequently-used query completions in the stored history that include the user-entered text 415.

Another way to formulate this most popular completion method is as follows. For convenience, we first define some terms and notations. Given a user input word sequence w1w2w3 . . . wi (which comprises a first word w1, a second word w2, . . . . , an ith word wi), we label this word sequence w1w2w3 . . . wi as a prefix. For a suggested completion w1w2w3, . . . , wiwi+1 . . . wn, we label wi+1wi+2 . . . , wn as a suffix. The most popular completion method looks for queries with the top-n highest conditional probability P(prefix|suffix).

In some cases, the candidate generation module 310 cannot find enough queries in the history of submitted queries that start with, or otherwise include, the user-entered text 415. For example, the most popular completion method used by the candidate generation module 310 may return zero results for auto-completion candidates when a user types in “gongsi software”, where “gongsi” is a recent tech startup that has job posts on an online service, but no users or too few users have submitted “gongsi software” as a search query.

In this case, the candidate generation module 310 may employ a back-off procedure that removes a portion of the user-entered text 415 to generate a modified version of the user-entered text 415 for use in re-searching the stored history of queries in an attempt to return a sufficient number of results for use as auto-completion candidates. In some example embodiments, the candidate generation module 310 is configured to remove the first word of the user-entered text 415 and re-search for queries starting with the remaining string. If no queries or an otherwise insufficient amount of queries are found, the candidate generation module 310 continues to remove the second word and re-search for queries starting with the remaining string, and continue removing the next word of the user-entered text 415 and re-searching with the remaining string until a sufficient amount of queries are found or there are no words left in the remaining string of the user-entered text. In the example above, the back-off procedure employed by the candidate generation module 310 removes the first word “gongsi” and searches for queries with prefix “software”, among which “software engineer” and “software developer” are most popular. In this example, the resulting suggested completions will be “gongsi software engineer”, “gongsi software developer” and so on.

Although the example of the back-off procedure above involves removing one word at a time, other portions of the user-entered text 415 may be removed. For example, in some example embodiments, one or more characters of a word, rather than the entire word, are removed from the user-entered text 415 at each instance of re-searching.

In some example embodiments, the candidate generation module 310 is configured to implement a back-off procedure that follows the following operational flow. First, the candidate generation module 310 searches a history of submitted search queries for submitted search queries comprising the user-entered text 415. The candidate generation module 310 then determines that less than a threshold amount of search queries comprises the user-entered text 415 have been submitted to the search engine. In some example embodiments, the threshold amount of search queries comprises one search query. However, a higher number of search queries can be used for the threshold amount. Based on the determination that less than the threshold amount of search queries comprising the user-entered text 415 have been submitted to the search engine, the candidate generation module 310 generates a modified version of the user-entered text 415. The modified version of the user-entered text 415 is absent a certain portion of the user-entered text 415. For example, the candidate generation module 310 may remove one or more terms from the user-entered text 415 in forming the modified version of the user-entered text. However, other types of portions (e.g., a single character of a word) of the user-entered text 415 may be removed to form the modified version of the user-entered text 415. The candidate generation module 310 then searches the history of submitted search queries for submitted search queries comprising the modified version of the user-entered text 415, and generates the auto-completion candidates based on one or more results of the searching of the history of submitted search queries for submitted search queries comprising the modified version of the user-entered text 415.

In response to, or otherwise based on, a determination by the candidate generation module 310 that a sufficient or threshold amount of auto-completion candidates have been generated, the neural network module 320 may then rank the generated auto-completion candidates. In some example embodiments, the neural network module 320 is configured to use a neural network model to rank the plurality of auto-completion candidates based on profile data of the user that entered the user-entered text 415. In some example embodiments, the neural network model is configured to generate a corresponding score for each one of the generated auto-completion candidates based on the user-entered text 415 and the profile data, and the ranking of the generated auto-completion candidates is based on the corresponding scores of the generated auto-completion candidates. In some example embodiments, the profile data comprises at least one of an industry, a job title, a company, and a location. However, other types of profile data are also within the scope of the present disclosure. In some example embodiments, the ranking of the generated auto-completion candidates comprises retrieving the profile data of the user from a database of a social networking service. However, the profile data of the user may be retrieved from other data sources as well.

In some example embodiments, the user interface module 330 is configured to cause at least a portion of the generated auto-completion candidates to be displayed in an auto-complete user interface element of the search field within the user interface of the computing device of the user based on the ranking prior to the user-entered text being submitted by the user as part of a search query. For example, the user interface module 330 may cause the top five ranked auto-completion candidates to be displayed in the auto-complete user interface element 425 of the search field 410 within the user interface 400 of the computing device of the user. It is contemplated that other top ranked portions of the ranked auto-completion candidates may be selected by the user interface module 330 for display.

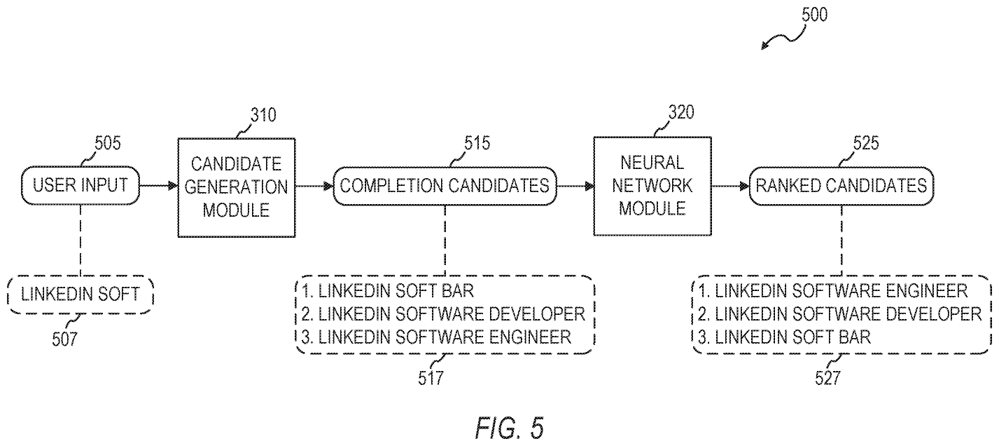

FIG. 5 illustrates an auto-completion pipeline 500, in accordance with an example embodiment. In FIG. 5, a user input 505, such as the user-entered text 415 in FIG. 4, is received by the candidate generation module 310. The candidate generation module 310 then generates auto-completion candidates 515, such as in the example embodiments of the candidate generation module 310 discussed in the present disclosure. The generated auto-completion candidates 515 are fed into the neural network module 320, which generates a ranking of the auto-completion candidates 525, such as in the example embodiments of the neural network module 320 discussed in the present disclosure. Examples of the user input 505, the generated auto-completion candidates 515, and the ranking of the auto-completion candidates 525 are shown in FIG. 5 within the dotted sections 507, 517, and 527, respectively.

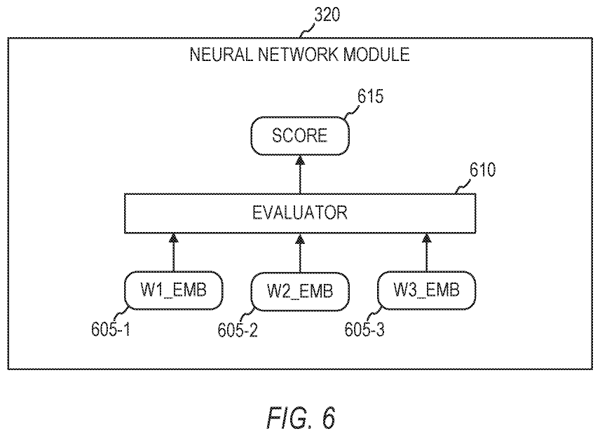

FIG. 6 illustrates the neural network module 320, in accordance with an example embodiment. In some example embodiments, the neural network module 320 comprises an evaluator 610. For each auto-completion candidate generated by the candidate generation module 310, the neural network module 320 converts each word in the auto-completion candidate into a corresponding embedding 605, and then feeds the corresponding embeddings 605 of the auto-completion candidate into an evaluator 610. For example, in FIG. 6, the neural network module 320 has converted three words of an auto-completion candidate into corresponding word embeddings 605-1, which corresponds to the first word (w1) in the auto-completion candidate, 605-2, which corresponds to the second word (w2) in the auto-completion candidate, and 605-3, which corresponds to the third word (w3) in the auto-completion candidate. The evaluator 610 is configured to generate a corresponding score 615 for the auto-completion candidate based on the word embeddings 605 using a neural network model.

In some example embodiments, the neural network model comprises one of two different neural network model architectures that are particularly useful and effective in determining the most relevant and useful auto-completion candidates to present to a user—a naive model evaluator and a language-model-based evaluator, which will be discussed in further detail below. The loss function is the same for these two architectures, and, for a suggested auto-completion candidate, measures the margin between a gold completion and the suggested auto-completion candidate. The gold completion is an actual submitted (e.g., clicked or selected) query, representing the standard by which the suggested auto-completion candidate is measured. In some example embodiments, the loss function is written as:

loss=log 1(1+e^{-Δscore}), where Δscore=score^{suggested query}−score^{gold completion}.

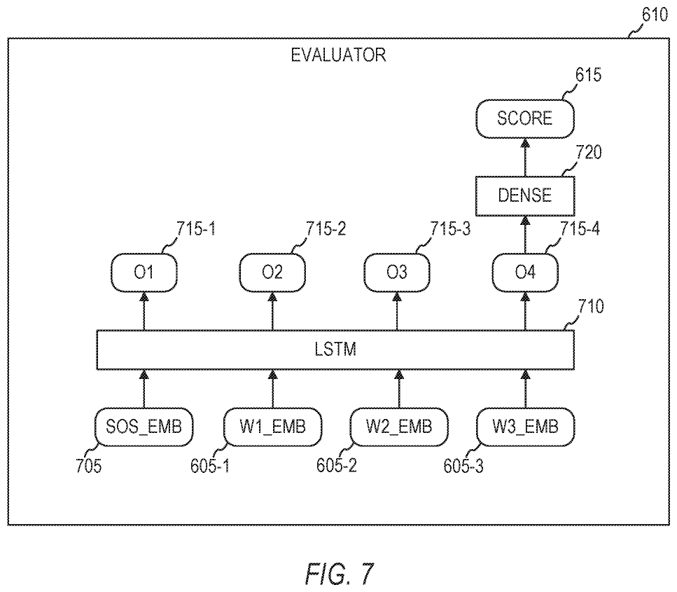

FIG. 7 illustrates the evaluator 610 comprising a naïve evaluator, in accordance with an example embodiment. In some example embodiments, the naïve evaluator comprises a sequence-to-sequence model based on Long Short-Term Memory (LSTM) cells or units, which is shown in FIG. 7 as LSTM model 710. The naive evaluator takes the word embeddings 605 of the auto-completion candidates and feeds them into LSTM cells of the LSTM model 710, which encodes the word embeddings 605 and generates corresponding cell states 715 for each one of its cells (e.g., cell states 715-1, 715-2, 715-3, and 715-4 in FIG. 7). The naïve evaluator may also feed an embedding for a start-of-sentence padding 705 into the LSTM model 710 at the start of the word embeddings 605. The output of the last cell 715 is fed into a dense full connection layer 720 to generate the score. In some example embodiments, the dense full connection layer 720 is configured to perform classification on the features extracted by the convolutional layers of the neural network and downsampled by the pooling layers of the neural network. In some example embodiments, in the dense full connection layer 720, every node in the layer 720 is connected to every node in the preceding layer.

In some example embodiments, employing the naïve valuator shown in FIG. 7, or some variation thereof, the neural network module 320 is configured to rank the plurality of auto-completion candidates by, for each one of the plurality of auto-completion candidates, generating a corresponding embedding for each word in the one of the plurality of auto-completion candidates, inputting the corresponding embedding for each word in the one of the plurality of auto-completion candidates into a long short-term memory (LSTM) network of the neural network model, the LSTM network comprising a plurality of LSTM cells, and generating the corresponding score of the one of the plurality of auto-completion candidates using a state value of a last cell of the plurality of LSTM cells of the LSTM network.

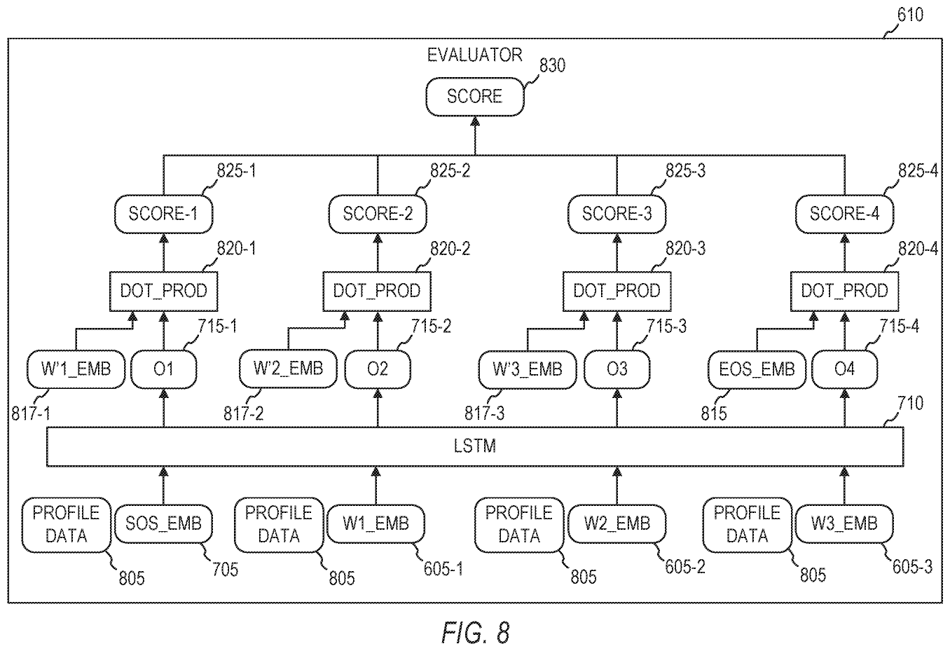

FIG. 8 illustrates the evaluator 610 comprising a language-model-based evaluator, in accordance with an example embodiment. Similar to the naive evaluator in FIG. 7, in FIG. 8, the language-model-based evaluator comprises an LSTM model 710. The language-model-based evaluator takes the word embeddings 605 of the auto-completion candidates and feeds them into LSTM cells of the LSTM model 710, which encodes the word embeddings 605 and generates corresponding cell states 715 for each one of its cells. The language-model-based evaluator may also feed an embedding for a start-of-sentence padding 705 into the LSTM model 710 at the start of the word embeddings 605. In FIG. 8, the language-model-based evaluator, generates corresponding scores 825 by feeding the current cell output 715 and the word embedding 817 of the next word into a dot product computation 820. The corresponding scores 825 are then summed to generate a final score 830 for the auto-completion candidate being evaluated. In the example shown in FIG. 8, an embedding for a start-of-sentence padding 705 is fed into the LSTM model 710 at the start of the word embeddings 605, and an end-of-sentence padding 815 is fed into the dot product computation 820-4 of the final cell state 715-4. In some example embodiments, the final score 830 for the auto-completion candidate is represented as:

$${score}_{i}^{{w}_{i}} αlog P ( {w}_{i} \vert {w}_{1} {w}_{2} … {w}_{i - 1} , SOS ) , \\ log P ( {w}_{i} \vert {w}_{2} … {w}_{i - 1} , sos ) = {score}_{i}^{{w}_{i}} - normalization {term}_{i} , and$$

$$normalization {term}_{i} = {\sum }_{j}^{\vert V \vert} {score}_{j}^{{w}_{j}} , \\ where \vert V \vert is the vocabulary size .$$

In some example embodiments, the computation of the normalization term is computed as the dot product of a cell output 715(oᵢ) and a weight vector:

normalization termᵢ=oᵢ·weight

Therefore, in some example embodiments, the sum of the scores is the probability of the whole completion:

$$score = {\sum }_{i}^{n} {score}_{i}^{{w}_{i}} - normalization {term}_{i} = {\sum }_{i}^{n} log P ( {w}_{i} \vert {w}_{1} {w}_{2} … {w}_{i} , sos ) = log P ( {w}_{1} {w}_{2} … {w}_{n} \vert sos ) = log P ( {w}_{1} {w}_{2} … {w}_{n} ) .$$

In some example embodiments, the profile data of the user for whom the auto-completion candidate has been generated (e.g., the user who entered the user-entered text 415 in FIG. 4) is fed into the neural network model of the evaluator 610, and is used to generate the score 830 for the auto-completion candidate. For example, the neural network module 320 may generate an embedding 805 for the profile data, and then concatenate the word embeddings 605 and the start-of-sentence padding 705 with the embedding 805 for the profile data before being fed into the LSTM model 710. Alternatively, the embedding 805 for the profile data may be concatenated with the word embeddings 817 and end-of-sentence padding 815 downstream from the LSTM model 710. Examples of profile data of the user include, but are not limited to, an industry of the user, a job title of the user, a company of the user, and a location of the user. Other types of profile data are also within the scope of the present disclosure. By using the profile data of the user in generating the corresponding scores for auto-completion candidates, the neural network module 320 improves the accuracy of the auto-completion system 216 in predicting auto-completion candidates for the user and thereby enables the auto-completion system 216 to present auto-completion candidates to the user that are most relevant to that user, and improves the user interface 400 of the auto-completion system 216.

In some example embodiments, employing the language-model-based evaluator shown in FIG. 8, or some variation thereof, the neural network module 320 is configured to rank the plurality of auto-completion candidates by, for each one of the plurality of auto-completion candidates, generating a corresponding embedding for each word in the one of the plurality of auto-completion candidates, generating a corresponding coherence score for each combination of a word with all of the words preceding the word in the auto-completion candidate, and generating the corresponding score of the one of the plurality of auto-completion candidates using the corresponding coherence scores of the combinations in the auto-completion candidate. In some example embodiments, the coherence score indicates a coherence level between the word and all of the words preceding the word. For example, for a situation in which the auto-completion candidate being scored is “linkedin software engineer”, a coherence score would be generated to indicate the coherence between the word “software” and the preceding word “linkedin”, and another coherence score would be generated to indicate the coherence between the word “engineer” and the preceding words “linkedin software.” In some example embodiments, the start-of sentence padding 705 and the end-of-sentence padding 815 are treated as words in the auto-completion candidate, and the coherence level being indicated by each coherence score would include the start-of-sentence padding 705 and the end-of-sentence padding 815 as words in the auto-completion candidate being scored.

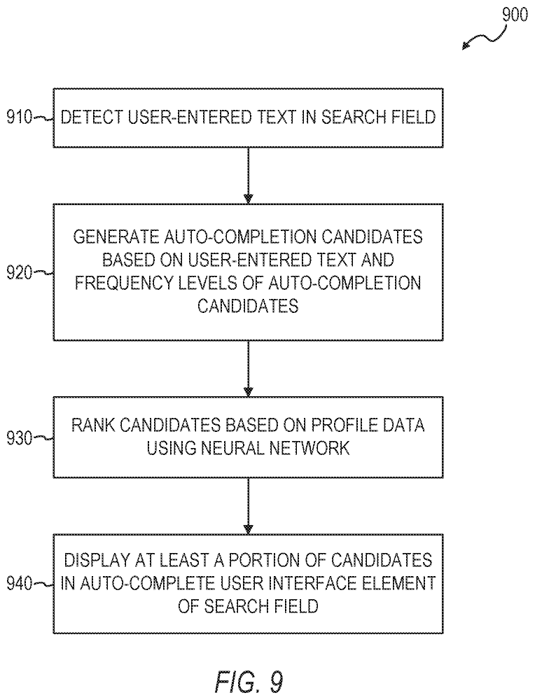

FIG. 9 is a flowchart illustrating a method 900 of providing an auto-completion function for a search field of a search engine, in accordance with an example embodiment. The method 900 can be performed by processing logic that can comprise hardware (e.g., circuitry, dedicated logic, programmable logic, microcode, etc.), software (e.g., instructions run on a processing device), or a combination thereof In one implementation, the method 900 is performed by the auto-completion system 216 of FIGS. 2-3, as described above.

At operation 910, the auto-completion system 216 detects user-entered text 415 in a search field 410 of a search engine. In some example embodiments, the user-entered text 415 has been entered via a user interface 400 of a computing device of a user.

At operation 920 the auto-completion system 216, in response to the detecting of the user-entered text 415 at operation 910, generates a plurality of auto-completion candidates 515 based on the user-entered text 415 and a corresponding frequency level for each one of the plurality of auto-completion candidates 515. In some example embodiments, each one of the plurality of auto-completion candidates 515 comprises predicted text absent from the user-entered text 415 and at least a portion of the user-entered text 415, and the frequency level indicates a number of times the corresponding predicted text has been included in a submitted search query along with the at least a portion of the user-entered text 415.

At operation 930, the auto-completion system 216, ranks the plurality of auto-completion candidates 515 based on profile data of the user using a neural network model. In some example embodiments, the neural network model is configured to generate a corresponding score for each one of the plurality of auto-completion candidates 515 based on the user-entered text 415 and the profile data, and the ranking of the plurality of auto-completion candidates 515 is based on the corresponding scores of the plurality of auto-completion candidates 515. In some example embodiments, the profile data comprises at least one of an industry, a job title, a company, and a location. However, other types of profile data are alsow within the scope of the present disclosure. In some example embodiments, the the ranking of the plurality of auto-completion candidates 515 comprises retrieving the profile data of the user from a database of a social networking service. However, the profile data may be retrieved from other data sources as well.

In some example embodiments, the ranking the plurality of auto-completion candidates 515 comprises, for each one of the plurality of auto-completion candidates 515, generating a corresponding embedding for each word in the one of the plurality of auto-completion candidates 515, inputting the corresponding embedding for each word in the one of the plurality of auto-completion candidates 515 into a long short-term memory (LSTM) network of the neural network model, the LSTM network comprising a plurality of LSTM cells, and generating the corresponding score of the one of the plurality of auto-completion candidates 515 using a state value of a last cell of the plurality of LSTM cells of the LSTM network.

In some example embodiments, the ranking of the plurality of auto-completion candidates 515 comprises, for each one of the plurality of auto-completion candidates 515, generating a corresponding embedding for each word in the one of the plurality of auto-completion candidates 515, generating a corresponding coherence score for each combination of a word with all of the words preceding the word in the auto-completion candidate, the coherence score indicating a coherence level between the word and all of the words preceding the word, and generating the corresponding score of the one of the plurality of auto-completion candidates using the corresponding coherence scores of the combinations in the auto-completion candidate.

At operation 940, the auto-completion system 216 causes at least a portion of the plurality of auto-completion candidates to be displayed in an auto-complete user interface element 425 of the search field 410 within the user interface 400 of the computing device of the user prior to the user-entered text 415 being submitted by the user as part of a search query.

It is contemplated that any of the other features described within the present disclosure can be incorporated into the method 900.

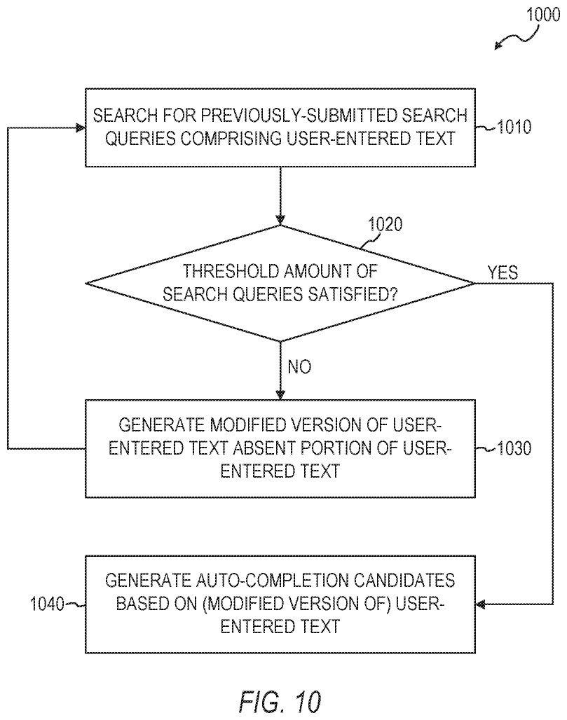

FIG. 10 is a flowchart illustrating a method 1000 of generating auto-completion candidates, in accordance with an example embodiment. The method 1000 can be performed by processing logic that can comprise hardware (e.g., circuitry, dedicated logic, programmable logic, microcode, etc.), software (e.g., instructions run on a processing device), or a combination thereof. In one implementation, the method 1000 is performed by the auto-completion system 216 of FIGS. 2-3, as described above.

At operation 1010, the auto-completion system 216 searches a history of submitted search queries for submitted search queries comprising the user-entered text 415. In some example embodiments, at operation 1010, the auto-completion system 216 uses the most popular completion method previously discussed.

At operation 1020, the auto-completion system 216 determines whether or not a threshold amount of search queries comprising the user-entered text 415 have been submitted to the search engine based on the search performed at operation 1010. If the auto-completion system 216 determines that the threshold amount of search queries comprising the user-entered text 415 have been submitted, then the method 1000 proceeds to operation 1040, where the auto-completion system 216 generates auto-completion candidates based on the results of the search performed at operation 1010 using the user-entered text 415.

If the auto-completion system 216 determines that the threshold amount of search queries comprising the user-entered text 216 have not been submitted, then the method 1000 proceeds to operation 1030, where the auto-completion system 216 generates a modified version of the user-entered text 415 based on the determination. In some example embodiments, the modified version is does not include a portion of the user-entered text 415. For example, the modified version may be formed by removing one or more characters or terms from the user-entered text 415. The method 1000 then returns to operation 1010, where the auto-completion system 216 searches the history of submitted search queries for submitted search queries comprising the modified version of the user-entered text 415. The auto-completion system 216 may repeat operations 1010, 1020, and 1030 until the auto-completion system 216 determines that the threshold amount of search queries has been satisfied, at which point, the auto-completion system 216 generates auto-completion candidates based on the results of the search(es) performed at operation 1010 using the modified version of the user-entered text 415 or using a combination of the user-entered text 415 along with one or more modified versions of the user-entered text 415.

It is contemplated that any of the other features described within the present disclosure can be incorporated into the method 1000.

### Example Mobile Device

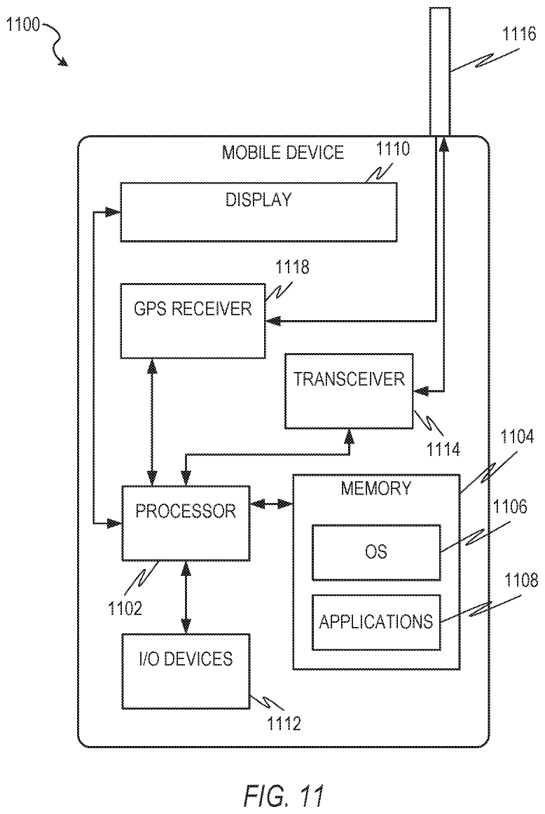

FIG. 11 is a block diagram illustrating a mobile device 1100, according to an example embodiment. The mobile device 1100 can include a processor 1102. The processor 1102 can be any of a variety of different types of commercially available processors suitable for mobile devices 1100 (for example, an XScale architecture microprocessor, a Microprocessor without Interlocked Pipeline Stages (MIPS) architecture processor, or another type of processor). A memory 1104, such as a random access memory (RAM), a Flash memory, or other type of memory, is typically accessible to the processor 1102. The memory 1104 can be adapted to store an operating system (OS) 1106, as well as application programs 1108, such as a mobile location-enabled application that can provide location-based services (LBSs) to a user. The processor 1102 can be coupled, either directly or via appropriate intermediary hardware, to a display 1110 and to one or more input/output (I/O) devices 1112, such as a keypad, a touch panel sensor, a microphone, and the like. Similarly, in some embodiments, the processor 1102 can be coupled to a transceiver 1114 that interfaces with an antenna 1116. The transceiver 1114 can be configured to both transmit and receive cellular network signals, wireless data signals, or other types of signals via the antenna 1116, depending on the nature of the mobile device 1100. Further, in some configurations, a GPS receiver 1118 can also make use of the antenna 1116 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry configured by software) be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

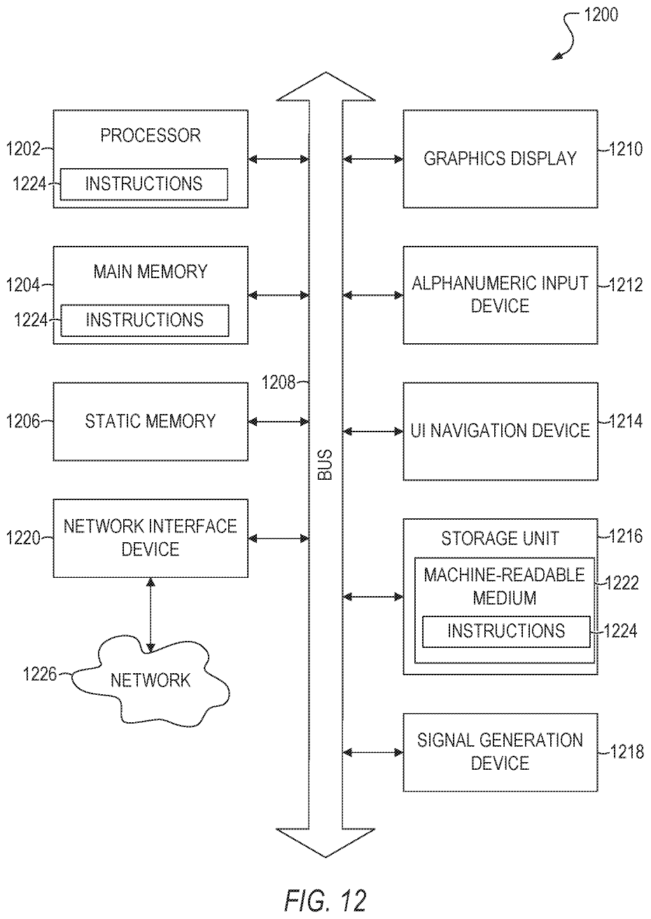

FIG. 12 is a block diagram of an example computer system 1200 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a graphics display unit 1210 (e.g., a liquid crystal display (LCD) or a cathode ray tube (CRT)). The computer system 1200 also includes an alphanumeric input device 1212 (e.g., a keyboard or a touch-sensitive display screen), a user interface (UI) navigation device 1214 (e.g., a mouse), a storage unit 1216, a signal generation device 1218 (e.g., a speaker) and a network interface device 1220.

### Machine-Readable Medium

The storage unit 1216 includes a machine-readable medium 1222 on which is stored one or more sets of instructions and data structures (e.g., software) 1224 embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media a centralized or distributed database, and/or associated caches and servers) that store the one or more instructions 1224 or data structures. The term “machine-readable medium” shall also be taken to include any tangible medium that is capable of storing, encoding or carrying instructions (e.g., instructions 1224) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
detecting, by a computer system having a memory and at least one hardware processor, user-entered text in a search field of a search engine, the user-entered text having been entered via a user interface of a computing device of a user;
in response to the detecting of the user-entered text, generating, by the computer system, a plurality of auto-completion candidates based on the user-entered text and a corresponding frequency level for each one of the plurality of auto-completion candidates, each one of the plurality of auto-completion candidates comprising predicted text absent from the user-entered text and at least a portion of the user-entered text, the frequency level indicating a number of times the corresponding predicted text has been included in a submitted search query along with the at least a portion of the user-entered text;
ranking, by the computer system, the plurality of auto-completion candidates based on profile data of the user using a neural network model, the neural network model being configured to generate a corresponding score for each one of the plurality of auto-completion candidates based on the user-entered text and the profile data, and the ranking of the plurality of auto-completion candidates being based on the corresponding scores of the plurality of auto-completion candidates; and
causing, by the computer system, at least a portion of the plurality of auto-completion candidates to be displayed in an auto-complete user interface element of the search field within the user interface of the computing device of the user based on the ranking prior to the user-entered text being submitted by the user as part of a search query.

2. The computer-implemented method of claim 1, wherein the generating the plurality of auto-completion candidates comprises:
searching a history of submitted search queries for submitted search queries comprising the user-entered text;
determining that less than a threshold amount of search queries comprising the user-entered text have been submitted to the search engine;
generating a modified version of the user-entered text based on the determining that less than the threshold amount of search queries comprising the user-entered text have been submitted to the search engine, the modified version being absent another portion of the user-entered text;
searching the history of submitted search queries for submitted search queries comprising the modified version of the user-entered text; and
generating the plurality of auto-completion candidates based on one or more results of the searching the history of submitted search queries for submitted search queries comprising the modified version of the user-entered text.

3. The computer-implemented method of claim 2, wherein the threshold amount of search queries comprises one search query.

4. The computer-implemented method of claim 2, wherein the other portion of the user-entered text comprises at least one term of the user-entered text.

5. The computer-implemented method of claim 1, wherein the profile data comprises at least one of an industry, a job title, a company, and a location.

6. The computer-implemented method of claim 1, wherein the ranking the plurality of auto-completion candidates comprises retrieving the profile data of the user from a database of a social networking service.

7. The computer-implemented method of claim 1, wherein the ranking the plurality of auto-completion candidates comprises:
for each one of the plurality of auto-completion candidates, generating a corresponding embedding for each word in the one of the plurality of auto-completion candidates;
for each one of the plurality of auto-completion candidates, inputting the corresponding embedding for each word in the one of the plurality of auto-completion candidates into a long short-term memory (LSTM) network of the neural network model, the LSTM network comprising a plurality of LSTM cells; and
for each one of the plurality of auto-completion candidates, generating the corresponding score of the one of the plurality of auto-completion candidates using a state value of a last cell of the plurality of LSTM cells of the LSTM network.

8. The computer-implemented method of claim 1, wherein the ranking the plurality of auto-completion candidates comprises:
for each one of the plurality of auto-completion candidates, generating a corresponding embedding for each word in the one of the plurality of auto-completion candidates;
for each one of the plurality of auto-completion candidates, generating a corresponding coherence score for each combination of a word with all of the words preceding the word in the auto-completion candidate, the coherence score indicating a coherence level between the word and all of the words preceding the word; and
for each one of the plurality of auto-completion candidates, generating the corresponding score of the one of the plurality of auto-completion candidates using the corresponding coherence scores of the combinations in the auto-completion candidate.

9. A system comprising:
at least one hardware processor; and
a non-transitory machine-readable medium embodying a set of instructions that, when executed by the at least one hardware processor, cause the at least one processor to perform operations, the operations comprising:
detecting user-entered text in a search field of a search engine, the user-entered text having been entered via a user interface of a computing device of a user;
in response to the detecting of the user-entered text, generating a plurality of auto-completion candidates based on the user-entered text and a corresponding frequency level for each one of the plurality of auto-completion candidates, each one of the plurality of auto-completion candidates comprising predicted text absent from the user-entered text and at least a portion of the user-entered text, the frequency level indicating a number of times the corresponding predicted text has been included in a submitted search query along with the at least a portion of the user-entered text;
ranking the plurality of auto-completion candidates based on profile data of the user using a neural network model, the neural network model being configured to generate a corresponding score for each one of the plurality of auto-completion candidates based on the user-entered text and the profile data, and the ranking of the plurality of auto-completion candidates being based on the corresponding scores of the plurality of auto-completion candidates; and
causing at least a portion of the plurality of auto-completion candidates to be displayed in an auto-complete user interface element of the search field within the user interface of the computing device of the user based on the ranking prior to the user-entered text being submitted by the user as part of a search query.

10. The system of claim 9, wherein the generating the plurality of auto-completion candidates comprises:
searching a history of submitted search queries for submitted search queries comprising the user-entered text;
determining that less than a threshold amount of search queries comprising the user-entered text have been submitted to the search engine;
generating a modified version of the user-entered text based on the determining that less than the threshold amount of search queries comprising the user-entered text have been submitted to the search engine, the modified version being absent another portion of the user-entered text;
searching the history of submitted search queries for submitted search queries comprising the modified version of the user-entered text; and
generating the plurality of auto-completion candidates based on one or more results of the searching the history of submitted search queries for submitted search queries comprising the modified version of the user-entered text.

11. The system of claim 10, wherein the threshold amount of search queries comprises one search query.

12. The system of claim 10, wherein the other portion of the user-entered text comprises at least one term of the user-entered text.

13. The system of claim 9, wherein the profile data comprises at least one of an industry, a job title, a company, and a location.

14. The system of claim 9, wherein the ranking the plurality of auto-completion candidates comprises retrieving the profile data of the user from a database of a social networking service.

15. The system of claim 9, wherein the ranking the plurality of auto-completion candidates comprises:
for each one of the plurality of auto-completion candidates, generating a corresponding embedding for each word in the one of the plurality of auto-completion candidates;
for each one of the plurality of auto-completion candidates, inputting the corresponding embedding for each word in the one of the plurality of auto-completion candidates into a long short-term memory (LSTM) network of the neural network model, the LSTM network comprising a plurality of LSTM cells; and
for each one of the plurality of auto-completion candidates,
generating the corresponding score of the one of the plurality of auto-completion candidates using a state value of a last cell of the plurality of LSTM cells of the LSTM network.

16. The system of claim 9, wherein the ranking the plurality of auto-completion candidates comprises:
for each one of the plurality of auto-completion candidates, generating a corresponding embedding for each word in the one of the plurality of auto-completion candidates;
for each one of the plurality of auto-completion candidates,
generating a corresponding coherence score for each combination of a word with all of the words preceding the word in the auto-completion candidate, the coherence score indicating a coherence level between the word and all of the words preceding the word; and
for each one of the plurality of auto-completion candidates, generating the corresponding score of the one of the plurality of auto-completion candidates using the corresponding coherence scores of the combinations in the auto-completion candidate.

17. A non-transitory machine-readable medium embodying a set of instructions that, when executed by at least one hardware processor, cause the processor to perform operations, the operations comprising:
detecting user-entered text in a search field of a search engine, the user-entered text having been entered via a user interface of a computing device of a user;
in response to the detecting of the user-entered text, generating a plurality of auto-completion candidates based on the user-entered text and a corresponding frequency level for each one of the plurality of auto-completion candidates, each one of the plurality of auto-completion candidates comprising predicted text absent from the user-entered text and at least a portion of the user-entered text, the frequency level indicating a number of times the corresponding predicted text has been included in a submitted search query along with the at least a portion of the user-entered text;
ranking the plurality of auto-completion candidates based on profile data of the user using a neural network model, the neural network model being configured to generate a corresponding score for each one of the plurality of auto-completion candidates based on the user-entered text and the profile data, and the ranking of the plurality of auto-completion candidates being based on the corresponding scores of the plurality of auto-completion candidates; and
causing at least a portion of the plurality of auto-completion candidates to be displayed in an auto-complete user interface element of the search field within the user interface of the computing device of the user based on the ranking prior to the user-entered text being submitted by the user as part of a search query.

18. The non-transitory machine-readable medium of claim 17, wherein the generating the plurality of auto-completion candidates comprises:
searching a history of submitted search queries for submitted search queries comprising the user-entered text;
determining that less than a threshold amount of search queries comprising the user-entered text have been submitted to the search engine;
generating a modified version of the user-entered text based on the determining that less than the threshold amount of search queries comprising the user-entered text have been submitted to the search engine, the modified version being absent another portion of the user-entered text;
searching the history of submitted search queries for submitted search queries comprising the modified version of the user-entered text; and
generating the plurality of auto-completion candidates based on one or more results of the searching the history of submitted search queries for submitted search queries comprising the modified version of the user-entered text.

19. The non-transitory machine-readable medium of claim 17, wherein the ranking the plurality of auto-completion candidates comprises:
for each one of the plurality of auto-completion candidates, generating a corresponding embedding for each word in the one of the plurality of auto-completion candidates;
for each one of the plurality of auto-completion candidates, inputting the corresponding embedding for each word in the one of the plurality of auto-completion candidates into a long short-term memory (LSTM) network of the neural network model, the LSTM network comprising a plurality of LSTM cells; and
for each one of the plurality of auto-completion candidates, generating the corresponding score of the one of the plurality of auto-completion candidates using a state value of a last cell of the plurality of LSTM cells of the LSTM network.

20. The non-transitory machine-readable medium of claim 17, wherein the ranking the plurality of auto-completion candidates comprises:
for each one of the plurality of auto-completion candidates, generating a corresponding embedding for each word in the one of the plurality of auto-completion candidates;
for each one of the plurality of auto-completion candidates, generating a corresponding coherence score for each combination of a word with all of the words preceding the word in the auto-completion candidate, the coherence score indicating a coherence level between the word and all of the words preceding the word; and
for each one of the plurality of auto-completion candidates, generating the corresponding score of the one of the plurality of auto-completion candidates using the corresponding coherence scores of the combinations in the auto-completion candidate.
